(19) United States
(12) Patent Application Publication
(10) Pub. No.: US 2010/0241865 A1
(43) Pub. Date: Sep. 23, 2010

(54) One-Time Password System Capable of Defending Against Phishing Attacks

(75) Inventors: Ming-Che Chang, Taoyuan County (TW); Han-Chieh Sun, Taoyuan County (TW); Pao-Chung Chang, Taoyuan County (TW); Gan-How Chang, Taoyuan County (TW)

Correspondence Address: SCHMEISER OLSEN & WATTS, 18 E UNIVERSITY DRIVE, SUITE # 101, MESA, AZ, 85201, US

(73) Assignee: Chunghwa Telecom Co., Ltd, Taoyuan County (TW)

(21) Appl. No.: 12/407,631

(22) Filed: Mar. 19, 2009

(51) Int. Cl. H04L 9/32; G06F 21/00

(52) U.S. Cl. 713/184; 726/9; 713/185

(57) ABSTRACT

A one-time password system capable of defending against on-line phishing attacks. The one-time password system is composed mainly of a Java smart card, a pre-end password calculation module, a post-end password registration module, a post-end password verification module and a post-end database. In the system, a Java smart card is used and message authentication code technology is relied upon to associate a login URL with a one-time password generation process, so that a user identification process against on-line phishing attacks can be achieved.

### BACKGROUND OF THE INVENTION

1. Field of the Invention

The present invention relates to a method for generating a one-time password, and particularly to a method for generating a one-time password by using a Java smart card and message authentication codes, which can prevent the password from being stolen via phishing attacks and thus secure the user's identity and information on the Internet.

2. Description of the Prior Art

There is currently no technology which can effectively and successfully prevent phishing attacks on the Internet. Hackers can easily steal a user's password produced from any type of one-time password generator via phishing attacks and the user's password and associated login information can therefore be stolen or abused. This problem is becoming more serious, particularly for one-time password systems used in electronic banking. In this regard, there is a need for a more secure password protection strategy to aid in the development of electronic commerce.

In view of the above, the conventional one-time password system still has to be improved. After a long term research and experiment, an improved one-time password system capable of defending against phishing attacks is finally developed and taken as the present invention.

### SUMMARY OF THE INVENTION

It is an object of the present invention to provide a highly secure one-time password system capable of defending against on-line phishing attacks by using a Java smart card and message authentication codes to generate a one time password, which can avoid the electric power dissipation issue generally associated with general hardware password generators, so that online user's identity can be secured.

The one-time password system capable of defending on-line phishing attacks according to the present invention is composed mainly of a Java smart card, a pre-end password calculation module, a post-end password registration module, a post-end password verification module and a post-end database.

The one-time password system defends against phishing for a user password and thus secures user's identity and information on the Internet by utilizing a registration process and a user identification process. The registration process includes generation of a preliminary password and login to the post-end database by using the preliminary password and user information, initialization of the Java smart card, installation of associated Applets and setting of a user card password, and encrypting and storing the preliminary password in the Java smart card. The user identification process includes calculation of the one-time password by the Java smart card at the pre-end and verifying and updating the password at the post-end.

These features and advantages of the present invention will be fully understood and appreciated from the following detailed description of the accompanying drawings.

### BRIEF DESCRIPTION OF THE DRAWINGS

FIG. 1 is an architecture diagram of a one-time password system capable of defending against phishing attacks according to the present invention;

FIG. 2 is a flow chart of a registration process of the one-time password system capable of defending against phishing attacks according to the present invention;

FIG. 3 is a flow chart of a pre-end one-time password calculation process of the one-time password system capable of defending against phishing attacks according to the present invention; and

FIG. 4 is a flow chart of a post-end password verification process of the one-time password system capable of defending against phishing attacks according to the present invention.

### DETAILED DESCRIPTION OF THE PREFERRED EMBODIMENT

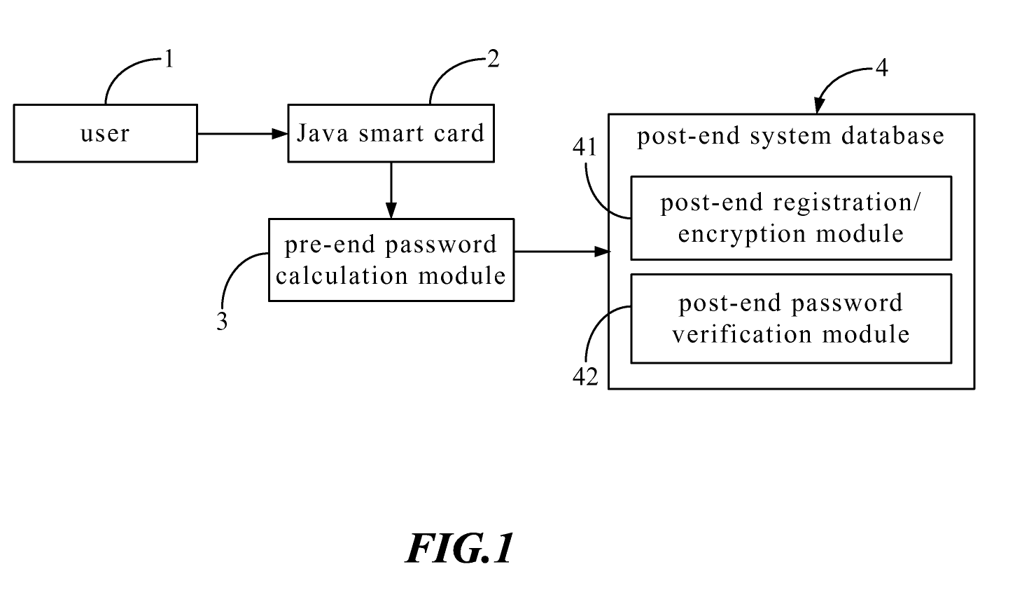

Referring to FIG. 1, an architecture diagram of a one-time password system capable of defending against phishing attacks according to the present invention is depicted therein.

The pre-end user 1 conducts a registration process and an identification process via the Java smart card 2.

The Java smart card 2 is used to store a previous password and calculate a one-time password. By using the Java smart card 2 and the pre-end password calculation module 3, the pre-end user 1 initiates the identification process by generating a one-time password by combining a message authentication code and a URL.

After the pre-end user 1 registers at a post-end system database 4, the pre-end password calculation module 3 associates the login URL with a one-time password generating process by using the Java smart card 2 and a message authentication code technology. In this case, an embedded component on a webpage cannot be forged and secure communications between the Java smart card 2 and external components can be achieved. Not only can the user's password be prevented from being stolen by any hacker via phishing attacks but the electric power dissipation problem associated with a general hardware password generator can be avoided.

The post-end system database 4 includes a post-end registration module 41 and a post-end password verification module 42. The user identification process is conducted in the post-end password verification module 42 and the pre-end password calculation module 3 of the Java smart card 2. The post-end registration/encryption module 41 generates a preliminary password at the registration stage and then login to the post-end database 4. Meanwhile, the post end registration/encryption module 41 encrypts and stores the preliminary password into the Java smart card 2 and thus provides it to the user 1.

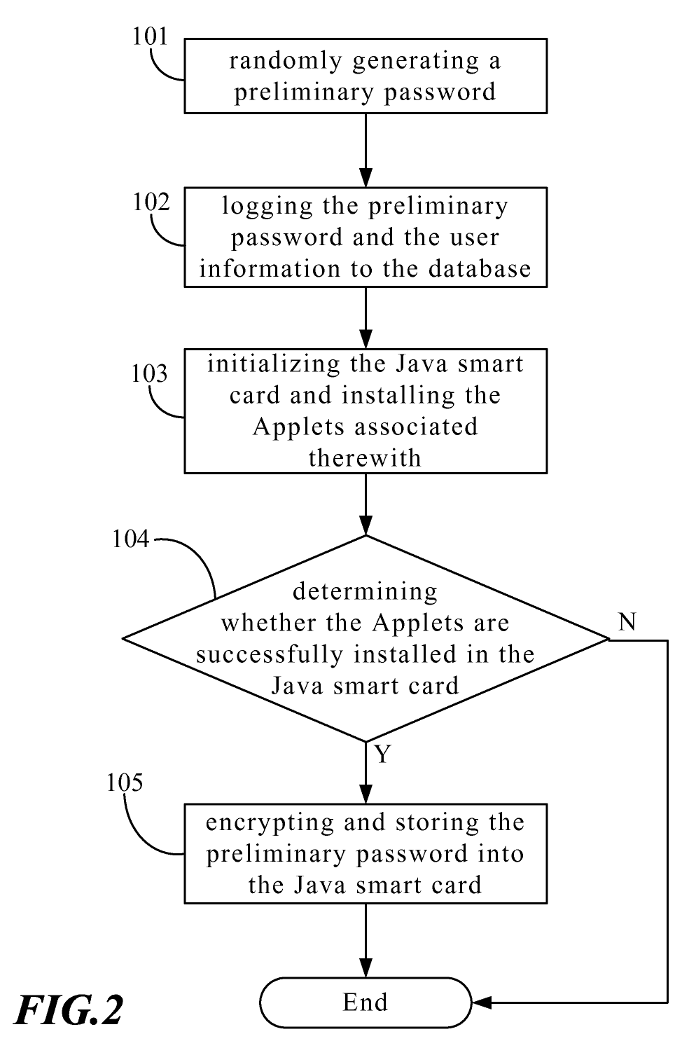

Referring to FIG. 2, a flow chart of the registration process of the one-time password system capable of defending against phishing attacks according to the present invention is shown therein. The steps of the registration process will be described in detail below.

Step 1: The system randomly generates a preliminary password (101).

Step 2: Login the post-end database by using the preliminary password and the user information (102). The database at least includes user identification information, the preliminary password and the login URL.

Step 3: The Java smart card is initialized and Applets associated therewith are installed (103).

Step 4: Determine whether the Applets are successfully installed in the Java smart card (104). If installation fails, the registration process is ended.

Step 5:If successful, the randomly generated preliminary password is encrypted and written into a protected region of the Java smart card (105), and is thus maintained by the user.

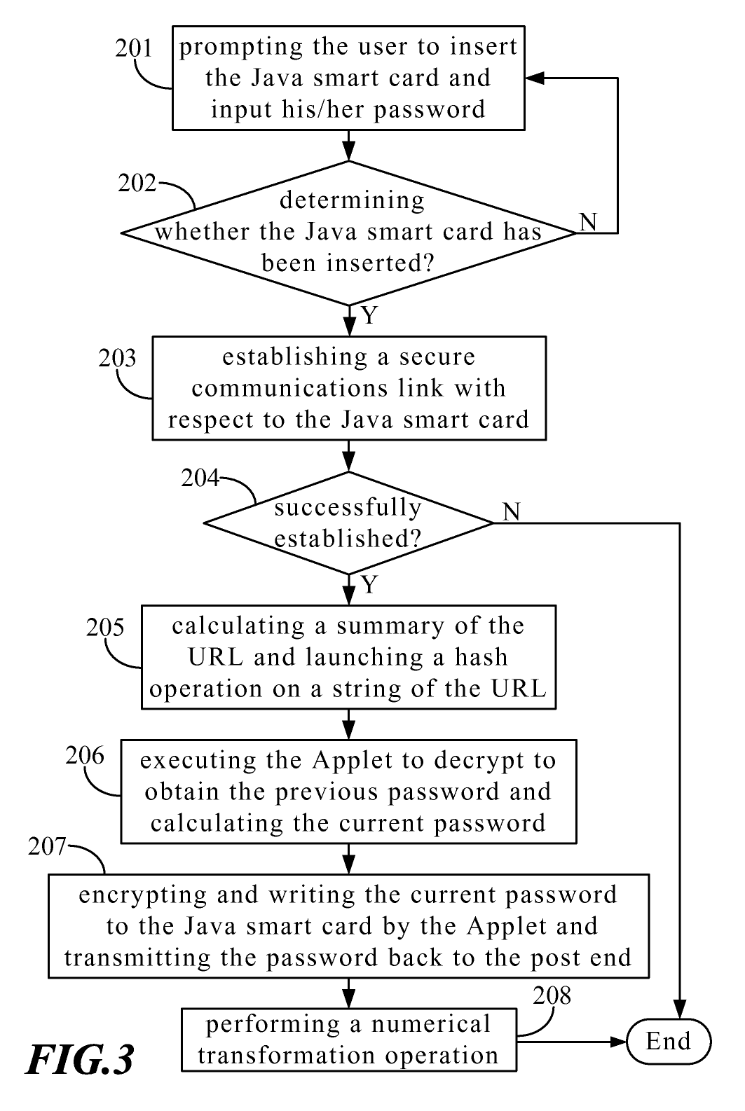

Referring to FIG. 3, it is a flow chart of a pre-end one-time password calculation process of the one-time password system capable of defending against phishing attacks according to the present invention. The system executes the Applet components in the Java smart card by using an embedded component on the webpage to calculate the one-time password. For example, the ActiveX component reads the URL string. The execution steps will be described in detail below.

Step 1: The user is prompted to insert the Java smart card and input his/her password (201).

Step 2: Next, it is determined whether the Java smart card is inserted (202). If not inserted, the process goes back to Step 1.

Step 3: If the Java smart card has been inserted, a secure communications link with respect to the Java smart card is established (203). Specifically, the ActiveX component establishes a secure communications channel compliant with the requirements of the Global Platform standardization organization with respect to the Java smart card.

Step 4: Whether the secure channel is successfully established is determined (204).

Step 5: If the secure channel is successfully established, a summary of the URL is calculated and a hash operation is made between a string of the URL and the default key Key 1 by following the rule URLhash=MD5 (URL∥Key1) (205).

Step 6: Applet is decrypted to obtain the previous password and the current password is calculated (206). A parameter URL hash is transmitted in an encrypted form and an Applet component is called to generate a one-time password. In this manner, the previous password is read out from a data protection region and decrypted. Then, an MD5 hash operation is made on the URL hash, the previous password (hereinafter OTPn-1) and a built-in key (i.e. Key1), and the string of the default key (i.e. Key2). As a result a preliminary version of the current password is obtained in the manner: OTPn=MD5 (URL hash∥OTPn-1∥Key2).

Step 7: The current password is encrypted and written to the Java smart card by the Applet and the password is transmitted back to the post end (207). That is, the Applet encrypts and writes the preliminary version of the current password OTPn to the data protection region and transmits OPTn. back to the post end.

Step 8: Numerical transformation is performed (208). Specifically, the ActiveX component applies a numerical transformation process on the 16 bytes hash data in the manner: OTPdigit=Hash2Number(Digit, OTPn). Then, the process is ended.

More specifically, the numerical transformation function Hash2Number extracts the preceding four bytes from the sixteen bytes hash data OTPn and then transforms the four bytes into a positive integer. Then, the positive integer is subject to the operation mod (10̂Digit) to obtain a set of digits as a current dynamic password of the user. As a result, the one-time password generation process made by the embedded component and the Java smart card in the preceding part of the one-time password system has been completed.

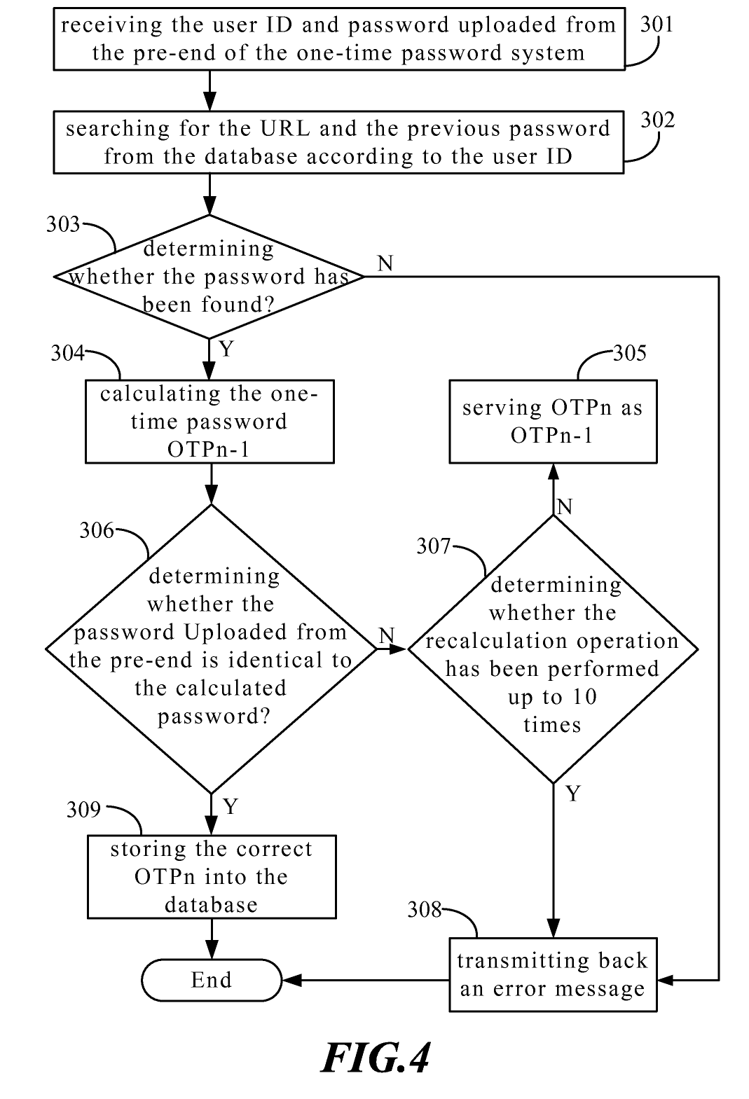

Referring to FIG. 4, a flow chart of a post-end one-time password calculation process of the one-time password system capable of defending against phishing attacks according to the present invention is shown therein. The steps of this process will be described in detail below.

Step 1: The user ID and password uploaded from the pre-end of the one-time password system is received (301).

Step 2: The URL and the previous password are found from the database according to the user ID (302).

Step 3: Whether the password is found is determined (303). If the password is not found, an error message is transmitted back (308) and the process is ended.

Step 4: If the password is found, the user identification information forwarded from the pre-end of the one-time password system is transmitted to the database to obtain the URL and the previous password OTPn-1 (304). At this time, the one-time password can be calculated in the following manner:
1. URLhash=MD5 (URL∥Key1),
2. OTPn=MD5 (URLhash∥OTPn-1∥Key2),and
3. OTPdigit=Hash2Number (Digit, OTPn).

Step 5: Determined whether the password uploaded from the pre-end is identical to the calculated password (306). That is, OPTdigit is compared to the password handed over from the user to see if the user is successfully identified.

Step 6: Determine whether the recalculation operation has been performed up to 10 times (307). If not and the two passwords are not identical, the post-end of the one-time password system takes OTPn as OTPn-1 to calculate the next OTPdigit to perform the password comparison task (305) again until the password identification task is successful within ten times.

Step 7: If the recalculation operation has been conducted up to ten times (307) and the identification task still failed, a failure-tolerant measure is taken, i.e. an error message is transmitted back (308). And the process is ended here.

Step 8: When the uploaded password is identical to the calculated password, the user identification task is successful. The system stores the correct OTPn into the database (309). Now the post-end password verification process is finished and the whole process is ended.

In addition, the system of the present invention can be used in the case where a user uses one Java smart card to get identified on multiple websites. In this case, an index management technology is added on the Java smart card so that the previous passwords corresponding to different websites can be stored, respectively. At this time, each of the websites should be assigned its exclusive index.

Moreover, the Java smart card and the message authentication code technology are, in this invention, used to associate the login URL with the process of the one-time password generation. In this manner, the system of the invention can avoid the threat brought from hackers for stealing user password via phishing attacks. As a result, on-line user identification security is improved.

Compared to the prior art, the one-time password system of this invention has following advantages.

1. The electric power dissipation issue involved with conventional hardware-based dynamic password generators can be avoided.

2. Phishing attacks by a hacker for stealing a password can be defended against.

3. The present invention provides flexibility of selecting the length of the password ranging from 1 to 10 digits.

4. In giving a user a new URL, only the URL field in the database at the server end should be updated. In this manner, the one-time password can be verified as usual.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A one-time password system capable of defending against phishing attacks, comprising:
a Java smart card storing a previous password and calculating a one-time password;
a pre-end password calculation module associating a login URL with a one-time password generating process by using an embedded component on a webpage and the Java smart card to calculate and generate a one-time password ranging from 1 to 10 digits;
a post-end registration/encryption module generating a preliminary password and login to a post-end database, and encrypting and storing the preliminary password into the Java smart card maintained by the user; and
a post-end password verification module calculating and verifying if a password inputted from the user is legal.

2. The system as claimed in claim 1, wherein the preliminary password is randomly generated, and the post-end registration/encryption module logs into the post-end database by using the preliminary password and a set of user information, encrypts the preliminary password by using a default key and stores the encrypted key into the Java smart card maintained by the user.

3. The system as claimed in claim 1, wherein the pre-end password calculation module calculates the one-time password by reading a character string of the URL and calculates a URL summary by using an embedded component on the webpage, establishing a secure communications link to the Java card, and generating the one-time password by calling an Applet component in the Java smart card by transmitting the URL summary in an encrypted form as a parameter.

4. The system as claimed in claim 1, wherein the post-end password verification module verifies the user password by receiving the user ID and password, searching for the previous password and the URL string from the database by referring to the user ID, calculating the one-time password by using the previous password and the URL string, comparing the uploaded password and the calculated password to determine if the user ID is successfully identified, re-calculating and re-comparing the uploaded password and the calculated password when the uploaded password and the calculated password are different, as a failure-tolerant measure, and updating the password of the user in the database after the password is successfully verified.

5. The system as claimed in claim 2, wherein the database comprises user identification information, preliminary password and login information.

6. The system as claimed in claim 3, wherein the one-time password is generated as a current dynamic password by reading and decrypting the previous password by the Applet, performing an MD5 hash operation with respect to the URL summary, the previous password, and the default key string to obtain the current password, encrypting and writing the current password into the data protection region and transmitting back the current password, and applying a numerical transformation function onto the current password to obtain the one-time password ranging from 1 to 10 digits to serve as the current dynamic password.

7. The system as claimed in claim 2, wherein the Java card is capable of being used with respect to a plurality of websites for identification, wherein the Java card is added with an index management mechanism so that the previous password for each of the plurality of websites is capable of being stored, and each of the plurality of websites is given an index when being installed.
